(19) United States
(12) Patent Application Publication
(10) Pub. No.: US 2015/0127627 A1
(43) Pub. Date: May 7, 2015

(54) METHOD FOR RECOMMENDING BROWSING OBJECTS

(71) Applicant: RICHPLAY INFORMATION CO., LTD., NEW TAIPEI CITY (TW)

(72) Inventors: HAO-TAO WO, SHANGHAI CITY (CN); YI-HSIANG CHEN, NEW TAIPEI CITY (TW)

(21) Appl. No.: 14/514,931

(22) Filed: Oct. 15, 2014

(30) Foreign Application Priority Data
Nov. 5, 2013 (TW) 102140188

(51) Int. Cl. G06F 17/30

(52) U.S. Cl. CPC G06F 17/30864; G06F 17/30905
USPC 707/706

(57) ABSTRACT

The present invention provides a method for recommending browsing objects. First, browse a first webpage via a first device. The first webpage is the search result of the search engine by searching a first object. Alternatively, the first object can be the webpage element of the first webpage. When the first device searches the first object or defines that the first object belongs to a first set, a first server can record that the first object belongs to the first set. Then the relationship among objects can be judged according to the user's behavior. When the second device searches the second object or defines that the second object belongs to a second set, compare the second object with the first object. As the second object coincides with the first object, the other first objects in the first set are transmitted to the second device for recommending browsing objects.

### FIELD OF THE INVENTION

The present invention relates generally to a method for recommending browsing objects, and particularly to a method for judging the relationship among objects by recording objects, such as keywords or webpage information, included into a set by users and recommending the other objects in the set when a procedure of an object belonging to the set is triggered by a user.

### BACKGROUND OF THE INVENTION

As information technologies develop, the processing and storage of massive information in the present day are no longer issues. The emergence of the Internet further enables rapid spreading of information. People can get a substantial amount of information through the Internet for satisfying demands to information in many aspects. Nonetheless, as the quantity of information grows drastically, the difficulty of extracting really useful information from massive information increases for users. Excess information decreases the efficiency of using information for users, which is just the newly derived and emerging information problem, the information overload. As described in the Buridan's donkey paradox in economics, excess choices (information) result in stagnation of decisions. Serious information overload can even cause information paralysis.

In order to help solving problems caused by information overload for users of the Internet, system developers developed information recommendation tools for recommending information to users spontaneously. By presenting in high priority the information possibly needed by users, the time required for the users on sifting the useful information from massive information can be saved. The usual method of the information recommendation tools is to search by using keywords and recommend information according to the search result. In addition, the information recommendation tools can extract the other keywords spontaneously from the users' personal information for performing weighed calculations and overall ordering. Thereby, the recommendation can be more personalized and customized and thus close to the needs of the users. Excellent information recommendation tools can provide information recommending service satisfying the users' demands. As a consequence, the users will trust the information recommendation tools and thus reinforcing the inclination of using the information recommendation tools.

Nonetheless, there is a bottleneck for the information recommendation tools according to the prior art, which use keywords for information searching and recommendation. It is difficult to build the relationship among keywords automatically. Take the brands of mobile phones for example. Users normally search a brand of mobile phones at a time. When a user searches or browses a brand of mobile phones, the system will not recommend other brands automatically as the keyword or the search result. Thereby, the information recommendation system cannot recommend effectively the information possibly needed by users. In addition, the current mechanism of automatic extraction or selection of keywords is not ideal, leading to deviation in the recommended result.

Owing to the problem, the present invention provides a novel method for recommending browsing objects. Instead of adopting on the “total automation” paradigm in the traditional information recommendation tools relying on keyword searching, the judgment behavior of users is involved in the information recommendation tools. Users can build relationship set freely and place the browsing objects related to their own judgment into the information management tools of the set. In addition, in the background, the system records the compares the objects, including keywords and webpage information, in the relationship set built by various users for finding out the related objects that are recorded repeatedly. Thereby, an object relationship model based on user judgment can be constructed. This object relationship model can be modified dynamically by subsequent construction of other relationship sets and inclusion of objects, and hence ensuring the accuracy of the recommended related objects.

Accordingly, the present invention provides a method for recommending browsing objects. First, browse at least a webpage from a first device. The first webpage can be the search result of a first object by the search engine connected from the first device. Alternatively, the first object can be the webpage information contained in the first webpage, such as a web address, a text segment, a picture, a video clip, or a piece of embedded external information. When the first device searches the first object or defines that the first object belongs to a first set, a first server connected with the first device can record that the first object belongs to the first set. The relationship among objects can be recorded by users' behaviors of searching objects or defining objects to a specific set and used as the basis for subsequent judgment. When a second device connected with the first server searches a second object or defines that the second object belongs to a second set, compare the second object with the first object. If the second object coincides with the first object, the first server will transmit the other first objects in the first set to the second device for achieving the efficacy of recommending browsing objects spontaneously.

### SUMMARY

An objective of the present invention is to provide a method for recommending browsing objects. According to the record of operations by a user in the server and the specific set including a plurality of objects related to the webpages browsed by the user, when another user's operation triggers comparison of a certain object and it is judged that the object coincides with another object, then the other objects in the set having the object are recommended to the user.

Another objective of the present invention is to provide a method for recommending browsing objects. The method provides a function of including a plurality of objects related to the webpages browsed by a user into a specific set. The user includes the objects judged related into the same set and organizes the objects for subsequent inquiry and application.

In order to achieve the objectives and efficacies described above, the present invention discloses a method for recommending browsing objects, which comprises steps of: a first device browsing at least a first webpage, and at least a first object being related to the first webpage; a first server connected with the first device recording that the first object belongs to at least a first set; comparing a second object of a second device connected to the first server with the first object of the first set; and the first server transmitting the first object of the first set to the second device when the second object coincides with the first object. The object can be a keyword or a piece of webpage information. The webpage information can be a web address, a text segment, a picture, a video clip, or a piece of embedded external information.

### BRIEF DESCRIPTION OF THE DRAWINGS

FIG. 1A shows a schematic diagram of device relationship according to a preferred embodiment of the present invention;

FIG. 1B shows a flowchart according to a preferred embodiment of the present invention;

FIG. 2A shows a schematic diagram of device relationship according to another preferred embodiment of the present invention; and

FIG. 2B shows a flowchart according to another preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

The present invention provides a method for recommending browsing objects. According to the record of operations by a user in the server and the specific set including a plurality of objects related to the webpages browsed by the user, when another user's operation triggers comparison of a certain object and it is judged that the object coincides with another object, then the other objects in the set having the object are recommended to the user. The action of defining certain objects belonging to a specific set reflects a user's judgment of the relationship of objects. Compared with the method for recommending browsing objects according to the prior art, the present invention recommends browsing objects with more friendliness and closer to users' needs. In addition, the present invention provides the function of independent definition of certain objects belonging to a specific set, which enables the present invention to be a tool for users to organize related browsing objects.

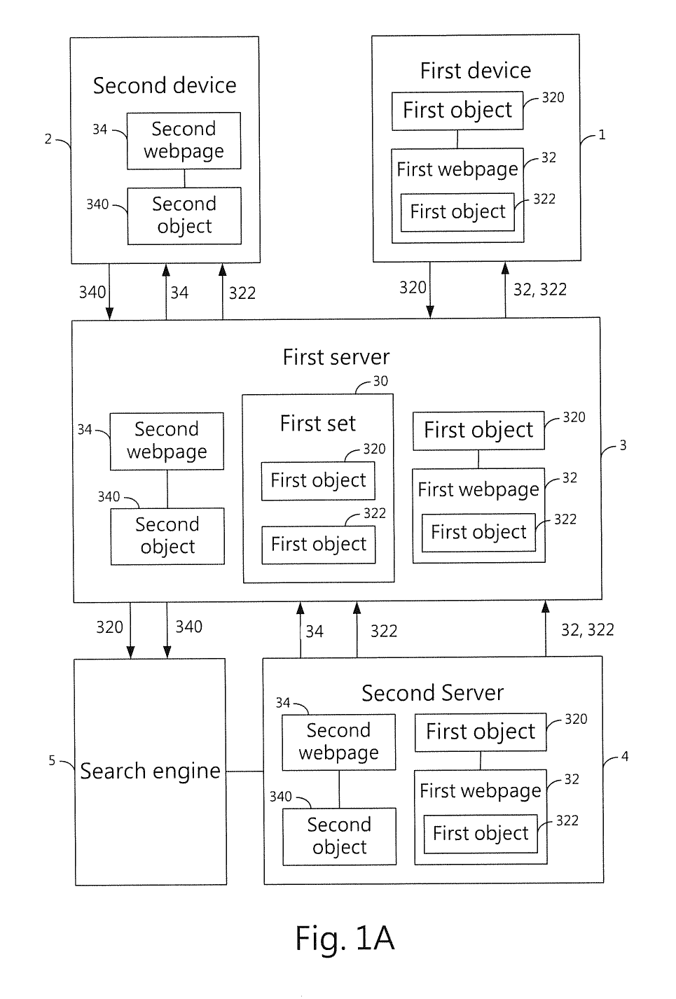

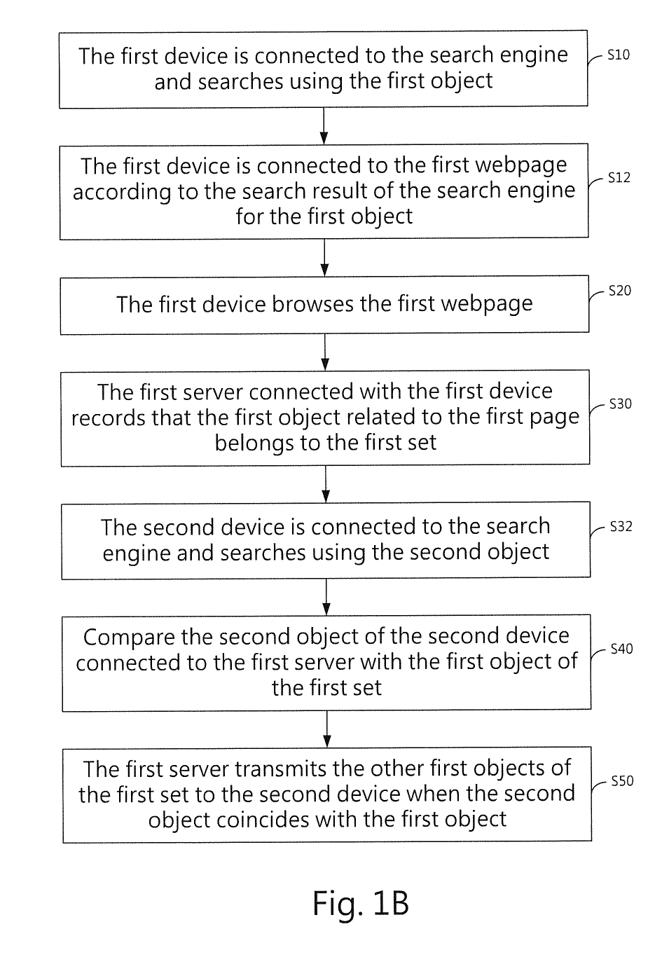

Please refer to FIG. 1A and FIG. 1B, which show a schematic diagram of device relationship and a flowchart according to a preferred embodiment of the present invention. As shown in FIG. 1A, the method for recommending browsing objects according to the present invention at least comprises a first device 1, a second device 2, and a first server 3. The first server 3 stores a first webpage 32. A first object 320 is related to the first webpage 32. The first webpage 32 includes another first object 322. The first server 3 records a first set 30. The plurality of first objects 320, 322 belong to the first set 30. The first device 1 produces the first object 320 and reads the first webpage 32 (including the first object 322) from the first server 3. The second device 2 produces a second object 340 and receives the first object 322 transmitted by the first server 3. The first object 320 or 322 can be a keyword, a piece of webpage information. The webpage information can be web address, a text segment, a picture, a video clip, or a piece of embedded external information.

As shown in FIG. 1B, the method for recommending browsing objects according to the present invention comprises at least the following steps:
Step S20: The first device browses the first webpage;
Step S30: The first server connected with the first device records that the first object related to the first page belongs to the first set;
Step S40: Compare the second object of the second device connected to the first server with the first object of the first set; and
Step S50: The first server transmits the first object of the first set to the second device when the second object coincides with the first object.

According to the present embodiment, the first webpage 32 is stored in the first server 3. In the step S20, the first device 1 reads the first webpage 32 from the first server 3 for browsing. In the step S30, the first server 3 records that the first object 320 is related to the first webpage 32 and that the first object 322 contained in the first webpage 32 belongs to the first set 30.

By implementing the steps S20 and S30, the user of the first device I can perform operations like cutting and pasting for placing various required first objects, such as the keywords used or the acquired webpage information, into various sets according to his judgment for categorization. For the user of the first device 1, the present invention provides the function of organizing usage of the first objects 320, 322, other keywords, or webpage information, which facilitates inquiry and usage of various objects in the future.

In the step S40, the second device 2 triggers the process that the first server 3 compares the second object 340 and the first object 320. In the step S50, when the first server 3 judges that the second object 340 of the second device 2 coincides with the first object 320, the rest first objects 322 in the first set 30, to which the first object 320 belongs, are transmitted to the second device 2.

By implementing the steps S40 and S50, the first server 3 can pick the first sets containing the first object 320 from various first sets built by cutting and pasting operations performed by various users on various webpages in advance. Then the other first objects, such as the first object 322, contained in the first sets containing the first object 320 are provided to the user of the second device 2. If there are a plurality of first sets containing the first object 320, the server 3 can compare the number of occurrence of the other first objects in various first sets. If the number of occurrence is high, it means more users judge that the first set is more related to the first object 320. Thereby, the first server 3 can provide in high priority the other first objects with higher occurrence in various first sets containing the first object 320. The other first objects related to the first object 320 are more likely needed by the user of the second device 2. For the user of the second device 2, the present invention provides the function of recommending the first object 322 related to the first object 320, other keywords, or webpage information. Thereby, the time required for processing specific information subject containing the first object 320 is saved.

The steps S30 and S40 can be triggered by the operations of the user of the first device 1 and the user of the second device 2. The user of the first device I can search using a first object, such as the first object 320 according to the present embodiment, and use the first object as the keyword. Alternatively, another first object, such as the first object 322 according to the present embodiment, is used as the webpage information and belongs to a first set 30 via the first device I. Thereby, the first server 3 connected with the first device 1 can record that the first object 320 or 322 belongs to the first set 30. The user of the second device 2 can search using a second object, such as the second object 340 according to the present embodiment, and use the second object as the keyword. Alternatively, another first object is used as the webpage information and belongs to a second set via the second device 2. Thereby, the first server 3 connected with the second device 2 can compare the second object 340 with the first object 320. According to the present embodiment, the user of the first device 1 and the user of the second device 2 trigger the steps S30, S40 by using the first object 320 and the second object 340 as the keyword for searching, respectively. The details will be described as follows.

The method according to the present embodiment of the present invention further comprises a search engine 5. According to the present embodiment, the first device 1 and the second device 2 are connected indirectly to the search engine 5 via the first server 3. Moreover, the following steps are further included before the step S20.
Step S10: The first device is connected to the search engine and uses the first object for searching; and
Step S12: The first device browses the first webpage according to the search result of searching the first object by the search engine.

In the step S10, the first device 1 is connected indirectly to the search engine 5 via the first server 3 and uses the first object 320 (keyword) to search. In the step S12, the first device 1 browses the first webpage 32 according to the search result of the first object 320.

In addition, according to the present embodiment, the following step is further included after the step S30 and before the step S40.
Step S32: The second device is connected to the search engine and uses the second object for searching.

In the step S30, the second device 2 is connected indirectly to the search engine 5 via the first server 3 and uses the second object 340 (keyword) to search. Then the step S40 is triggered. The first server 3 compares the second object 340 and the first object 320 for finding the first set 30 of the first object 320 coinciding with the second object 340.

Accordingly, by further connecting to the search engine 5 and implementing the steps S10 and S12 or the step S32, the user of the first device 1 and the user of the second user 2 can search via the search engine 5 by using the first object 320 and the second object 340, respectively. Afterwards, the steps S30 and S40 are executed subsequently.

The first webpage 32 (and the first object 322 contained in the first webpage 32) according to the present embodiment and a second webpage 34 related to the second object 340 have backup in the first server 3. The origin of the first webpage 32 and the second webpage 34 can be a second server 4 further contained in the figure. The second server 4 stores the first and second webpages 32, 34. The first and second devices 1, 2 are connected indirectly to the second server 4, respectively. Then, in the step S12, according to the search result of the first object 320 by the search engine 5, they are connected indirectly to the second server 4 and acquire the first webpage 32. In addition, after the step S32, according to the search result of the second object 340 by the search engine 5, they are connected indirectly to the second server 4 and acquire the second webpage 34.

By disposing the above devices and implementing the steps S10˜S50, the method for recommending browsing objects according to the present invention can be applied to the first server 3 and used as a relay for connecting the first and second devices 1, 2 to the search engine 5 and the second server 4. The present invention provides a tool of organizing browsing objects such as keywords or webpage information for users. In addition, by using the relationship among the browsing objects according to the judgment behaviors by which users organize them, when another user uses one of the browsing objects, the related browsing objects judged by previous users can be recommended spontaneously.

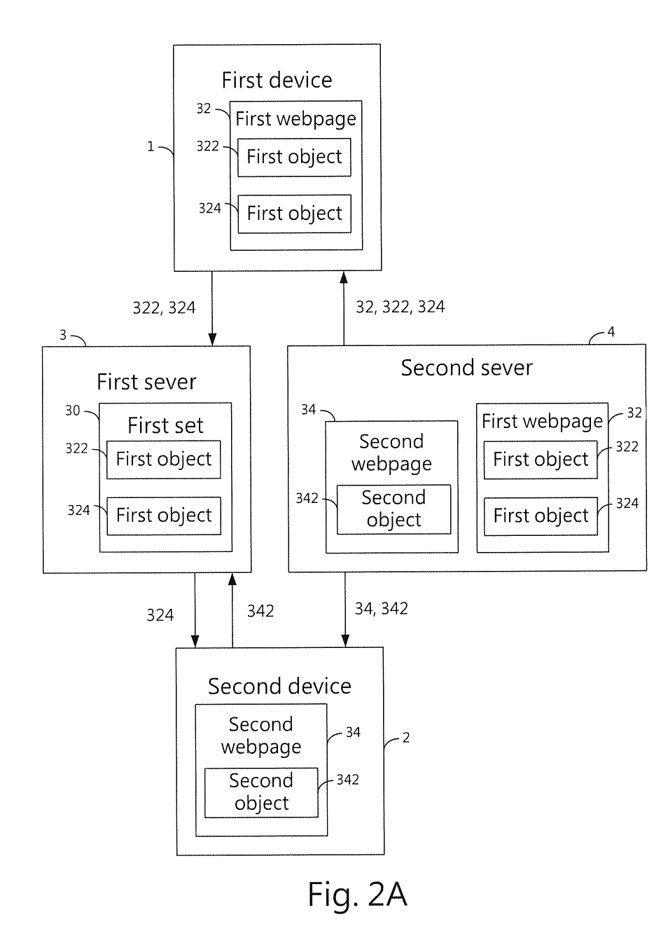

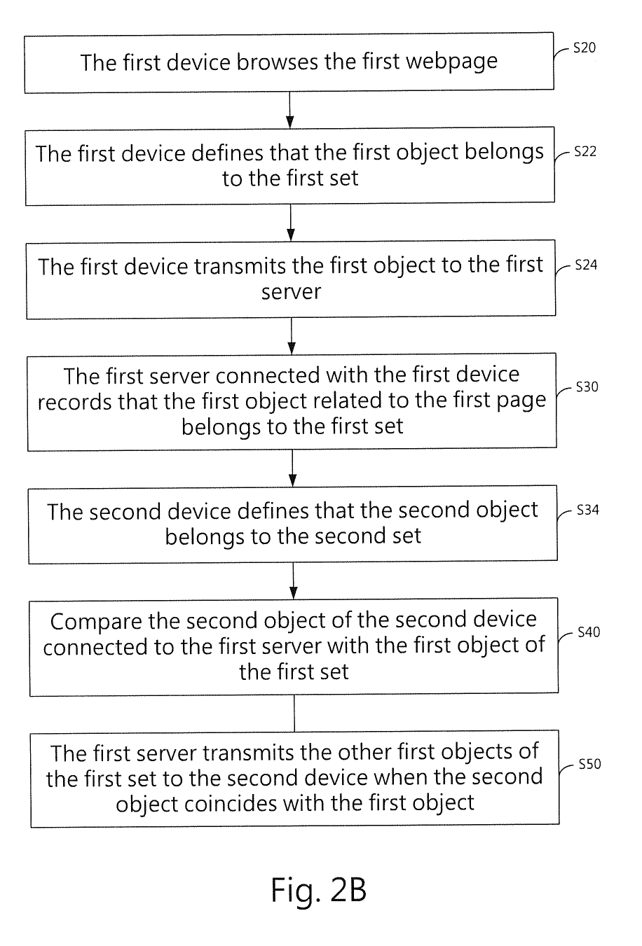

Please refer to FIG. 2A and FIG. 2B, which show a schematic diagram of device relationship and a flowchart according to another preferred embodiment of the present invention. As shown in FIG. 2A, in addition to a first device 1, a second device 2, and a first server 3, the method for recommending browsing objects according to the present embodiment further comprises a second server 4. The second server 4 stores a first webpage 32, a second webpage 34, first objects 322, 324 contained in the first webpage 32, and a second object 342 contained in the second webpage 34. The first device 1 reads the first webpage 32 and the first objects 322, 324 contained in the first webpage 32 from the second server 4 and transmits the first objects 322, 324 to the first server 3. The first server 3 stores the first objects 322, 324 and records a first set 30. The first objects 322, 324 belong to the first set 30. The second device 2 reads the second webpage 34 and the second object 342 contained in the second webpage 34 from the second server 4, transmits the second object 342 to the first server 3, and receives the first object 324 transmitted by the first server 3.

As shown in FIG. 2B, after the step S20 and before the step S30, the method for recommending browsing objects according to the present invention further comprises the following steps:
Step S22: The first device define that the fits objects belong to the first set; and
Step S24: The first device transmits the first objects to the first server.

In the step S22, the user of the first device 1 defines through the first device 1 that the first objects 322, 324 belong to the first set 30. The definition can be done by using the operation similar to adding a webpage to the bookmark, such as selecting the first objects 322, 324 and dragging them to the first set 30. In the step S24, the first device 1 transmits the first objects 322, 324 to the first server 3 for triggering the step S30, in which the first server 3 records that the first objects 322, 324 belong to the first set 30.

Moreover, after the step S30 and before the step S40, the present embodiment further comprises the following step:
Step S34: The second device defines that the second object belongs to the second set.

In the step S34, the user of the second device 2 defines through the second device 2 that the second object 342 belongs to the second set (not shown in the figure) for trigger execution of the step S40, in which the first server 3 compares the second object 342 with the first object 322 for finding the first set 30 to which the first object 322 coinciding with the second object 342 belong. Then in the step S50, the first server 3 transmits the other first objects in the first set 30, such as the first object 324, to the second device 2 for recommending to the user of the second device 2.

According to the present embodiment, the first and second devices 1, 2 are connected independently to the first and second servers 3, 4, respectively. The first webpage 32, the first object 322 contained in the first webpage 32, the second webpage 34, and the second object 342 contained in the second webpage 34 are stored in the second server 4. In the step S24, the first server 3 can backup the first objects 322, 324. Besides, in the step S22 or S34, the operation of the first device defining that the first objects 322, 324 belong to the first set 30 or the second device 2 defining that the second object 342 belongs to the second set can be detected by a resident background program. The program notifies the first server 3 when the first device 1 or the second device 2 performs the defining operation and enables the first server 3 to execute the step S30 for recording that the first objects 322, 324 belong to the first set 30, or the steps S40, S50 for comparing the second object 342 with the first object 322. Thereby, the other first objects, such as the first object 324, in the first set 30, to which the first object 322 coinciding with the second object 342 belong, can be recommended.

By disposing the above devices and implementing the steps S10˜S50, the method for recommending browsing objects according to the present invention can be applied to the condition in which the first and second device 1, 2 are connected concurrently to the first and second server 3, 4, respectively. Thereby, like the first embodiment, the efficacies of providing users with a tool for organizing browsing objects and recommending related browsing objects spontaneously can be achieved.

To sum up, according to the method for recommending browsing objects of the present invention, by the user's behavior of including browsing objects such as keywords or webpage information into a specific set, the relationship among browsing objects is built. Then the browsing objects in the related set can be recommended to users spontaneously for saving the time required the users search information.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A method for recommending browsing objects, comprising steps of:
a first device browsing at least a first webpage, and at least a first object being related to said first webpage;
a first server connected with said first device recording that said first object belongs to at least a first set;
comparing a second object of a second device connected to said first server with said first object of said first set; and
said first server transmitting said first object of said first set to said second device when said second object coincides with said first object.

2. The method for recommending browsing objects of claim 1, and before said step of said first device browsing said first webpage further comprising steps of:
said first device connecting to a search engine and searching using said first object; and
said first device browsing said first webpage according to the search result of said search engine by searching said first object.

3. The method for recommending browsing objects of claim 1, wherein said first device reads said first webpage via said first server or a second server connected with said first server.

4. The method for recommending browsing objects of claim 1, wherein said first device reads said first webpage via a second server connected with said first device.

5. The method for recommending browsing objects of claim 1, wherein said first object is a keyword or a piece of webpage information.

6. The method for recommending browsing objects of claim 5, wherein said webpage information is a web address, a text segment, a picture, a video clip, or a piece of embedded external information.

7. The method for recommending browsing objects of claim 1, and after said step of said first device browsing said first webpage and before said step of said first server connected with said first device recording that said first object belongs to said first set, further comprising a step of said first device defining that said first object belongs to said first set.

8. The method for recommending browsing objects of claim 7, and after said step of said first device defining that said first object belongs to said first set and before said step of said first server connected with said first device recording that said first object belongs to said first set, further comprising a step of said first device transmitting said first object to said first server.

9. The method for recommending browsing objects of claim 1, and after said step of said first server connected with said first device recording that said first object belongs to said first set and before said step of comparing said second object of said second device connected to said first server with said first object of said first set, further comprising a step of said second device connecting to a search engine and searching using said second object.

10. The method for recommending browsing objects of claim 1, and after said step of said first server connected with said first device recording that said first object belongs to said first set and before said step of comparing said second object of said second device connected to said first server with said first object of said first set, further comprising a step of said second device defining that said second object belongs to at least a second set.

11. The method for recommending browsing objects of claim 10, and after said step of said second device defining that said second object belongs to said second set and before said step of comparing said second object of said second device connected to said first server with said first object of said first set, further comprising a step of said second device transmitting said second object to said first server.
